(19) United States
(12) Patent Application Publication
(10) Pub. No.: US 2026/0148487 A1
(43) Pub. Date: May 28, 2026

(54) NEURAL DIRECTIONAL ENCODING FOR SPECULAR APPEARANCE GENERATION

(71) Applicants: Adobe Inc., San Jose, CA (US); The Regents of the University of California, Oakland, CA (US)

(72) Inventors: Sai Bi, San Jose, CA (US); Zexiang Xu, San Jose, CA (US); Liwen Wu, La Jolla, CA (US); Kalyan Sunkavalli, San Jose, CA (US); Kai Zhang, San Jose, CA (US); Iliyan Georgiev, London (GB); Fujun Luan, San Jose, CA (US); Ravi Ramamoorthi, Carlsbad, CA (US)

(21) Appl. No.: 18/959,422

(22) Filed: Nov. 25, 2024

(51) Int. Cl. G06T 15/50

(52) U.S. Cl. CPC G06T 15/506

(57) ABSTRACT

In some embodiments, a computing system accesses multiple input images of a specular object with a scene. The computing system encodes near-field interreflections of the scene on the specular object to obtain a first set of feature representations of the specular object in multiple viewing directions based on the multiple input images. The computing system encodes far-field reflections of the scene on the specular object to obtain a second set of feature representations in the multiple viewing directions based on the multiple input images. The computing system determines a set of specular color values for the specular object in the multiple viewing directions based on the first set of feature representations and the second set of feature representations using a multi-layer perceptron algorithm. The computing system renders the specular object representation at least based on the set of specular color values using a neural rendering algorithm.

### FIELD OF THE INVENTION

This disclosure relates generally to generative artificial intelligence. More specifically, but not by way of limitation, this disclosure relates to neural directional encoding (NDE) for specular appearance generation.

### BACKGROUND OF THE INVENTION

Specular objects such as metals, plastics, glossy paints, or silken cloth can have visually compelling appearances. Specular object rendering has a wide variety of applications in computer graphics, computer vision, virtual reality, and augmented reality. Many tools are available for generating geometric representations, for example neural radiance fields (NeRF) methods. It often requires capturing both geometry and view-dependent appearances in photographs of a specular object to synthesize novel views of the specular object and generate the specular appearance of the specular object.

### BRIEF SUMMARY OF THE INVENTION

Certain embodiments involve neural directional encoding for specular appearance generation. In one example, a computing system accesses multiple input images of a specular object with a scene. The computing system encodes near-field interreflections of the scene on the specular object to obtain a first set of feature representations of the specular object in multiple viewing directions based on the multiple input images. The computing system encodes far-field reflections of the scene on the specular object to obtain a second set of feature representations in the multiple viewing directions based on the multiple input images. The computing system determines a set of specular color values for the specular object in the multiple viewing directions based on the first set of feature representations and the second set of feature representations using a multi-layer perceptron algorithm. The computing system renders the specular object representation at least based on the set of specular color values using a neural rendering algorithm.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a specular appearance generation application provides a specular object rendering with specular appearance including near-field interreflections and far-field reflections, according to certain embodiments of the present disclosure.

FIG. 2 depicts an example of a process 200 providing a specular object model with specular color representing far-field reflection features and near-field reflection features, according to certain embodiments of the present disclosure.

FIG. 3 depicts an example of a diagram for generating a specular appearance for a specular object based on neural directional encoding, according to certain embodiments of the present disclosure.

FIG. 4A depicts an example of a comparison of specular object renderings with synthetic scenes using different baseline methods and the present method, according to certain embodiments of the present disclosure.

FIG. 4B depicts closed-up inset images in FIG. 4A, according to certain embodiments of the present disclosure.

FIG. 5 depicts an example of a comparison of specular object renderings with real scenes using different baseline methods and the present method, according to certain embodiments of the present disclosure.

FIG. 6 depicts an example of the computing system for implementing certain embodiments of the present disclosure.

### DETAILED DESCRIPTION OF THE INVENTION

Certain embodiments involve neural directional encoding for specular appearance generation. For instance, a computing system accesses multiple input images of a specular object with a scene in different viewing directions. The specular object has a smooth or glossy surface like a mirror which reflects light rays at the same angle as they hit the surface. A scene is a setting or an environment around the specular object. An input image depicts the specular object including reflections of the scene on the surface of the specular object. The computing system encodes far-field reflections of the scene on the specular object to obtain a first set of feature representations of the specular object in multiple viewing directions based on the multiple input images. Far-field reflections are reflections of the scene or object far from the specular object, which can be considered as the background of the specular object, for example, clouds, buildings, trees, etc. The computing system encodes near-field interreflections of the scene on the specular object to obtain a second set of feature representations in the multiple viewing directions based on the multiple input images. Near-field interreflections are reflections of reflected light rays from other objects close to a specular object. The objects close to the specular object can be considered as the foreground of the specular object. Spatially varying near-field interreflections are key effects in rendering the specular objects, besides far-field reflections. These effects cannot be accurately modeled by spatio-angular parameterization in the existing methods, whose directional encoding does not depend on the position. In contrast, the computing system of the present disclosure uses a novel spatio-spatial parameterization by cone-tracing a spatial feature grid to encode near-field interreflections. The cone tracing accumulates spatial encodings along a queried direction and position, thus it is spatially varying. Instead of only considering single-bounce or diffusing interreflections, the near-field feature representation in the present disclosure can model general multi-bounce reflection effects. The computing system determines a set of specular color values for the specular object in the multiple viewing directions based on the first set of feature representations and the second set of feature representations using a multi-layer perceptron algorithm. The computing system renders a specular object representation based on the set of specular color values.

The following non-limiting example is provided to introduce certain embodiments. In this example, a specular appearance generation system communicates with a client device over a network. The client device provides multiple input images of a specular object to the specular appearance generation system.

In some examples, the specular appearance generation system encodes far-field reflections of the scene on the specular object into a cubemap to obtain a first set of feature representations based on the multiple input images. The first set of feature representations are cubemap-based far-field feature representations. The computing system of the present disclosure performs feature-grid-based encoding in the directional domain, to represent reflections from distant sources using learnable feature vectors stored on a cubemap representing a global environment. High-frequency spatial and directional signals can be learned locally using feature-grid-based encoding in the directional domain, thus reducing the size of a multi-layer perceptron (MLP) algorithm required to decode high-frequency far-field reflections. The specular appearance generation system encodes near-field interreflections of the scene by cone-tracing a spatial feature grid to obtain the second set of feature representations. The second set of feature representations of the specular object are cone-traced near-field feature representations.

The specular appearance generation system determines a set of specular color values for the specular object in the multiple viewing directions based on the first set of feature representations and the second set of feature representations using an MLP algorithm. In some examples, the specular appearance generation system decodes the first set of feature representations to a first set of specular color values representing far-field reflections, decodes the second set of feature representations to a second set of specular colors representing near-field reflections using the decoding algorithm, and then blends the first set of specular colors and the second set of specular colors to obtain an aggregate set of specular colors of the specular object. In some examples, the specular appearance generation system blends or combines the first set of feature representations and the second set of feature representations to obtain an aggregate set of feature representations, and then decodes the aggregate set of feature representations to obtain an aggregated set of specular colors of the specular object. Existing methods for specular appearance generation commonly obtain view-dependent specular colors by decoding spatial features and encoded direction, which requires a large MLP algorithm and exhibits slow convergence with analytical directional encoding functions. In contrast, the MLP algorithm used by the specular appearance generation system of the present disclosure has a much smaller size since the two sets of feature representations are learned and encoded locally in the directional domain.

The specular appearance generation system renders a specular object representation based on the set of specular color values using a neural rendering algorithm, for example a neural radiance fields (NeRF) algorithm. The specular object is modeled by a surface-based model including a signed distance field (SDF)-based geometry model with specular colors on the surface. The specular appearance generation system optimizes the SDF-based geometry model based on the set of specular colors using an Adam optimizer. In some examples, the specular appearance generation system provides the specular object representation in real time or near real time.

Certain embodiments of the present disclosure overcome the disadvantages of the prior art. Localized feature learning in the directional domain can reduce the MLP size required to model high-frequency far-field reflections. Near-field interreflections can be more accurately modeled by cone-tracing a spatial feature grid. Overall, the neural directional encoding (NDE) in the present disclosure achieves efficient and high-quality modeling of view-dependent effects.

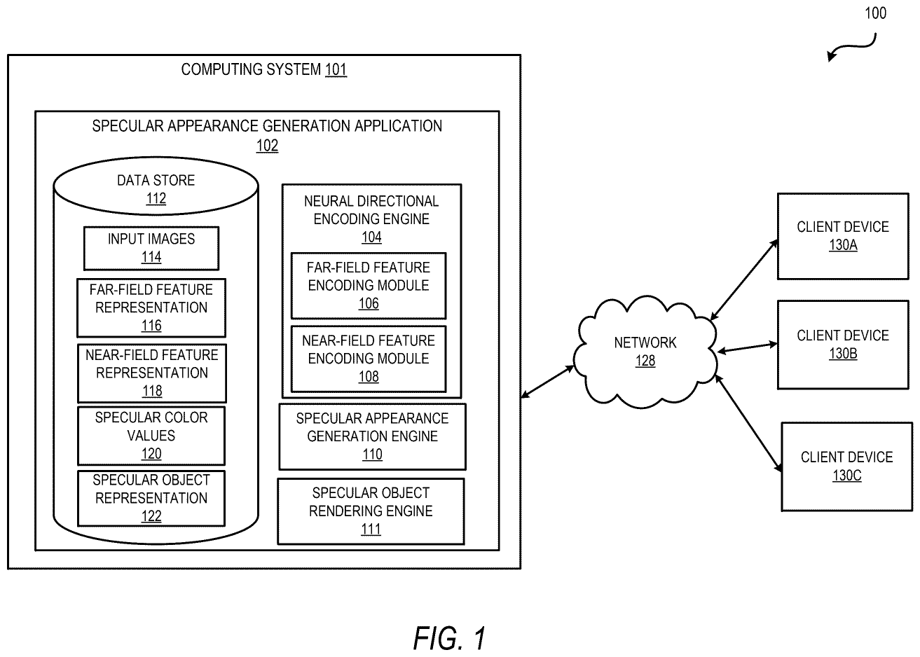

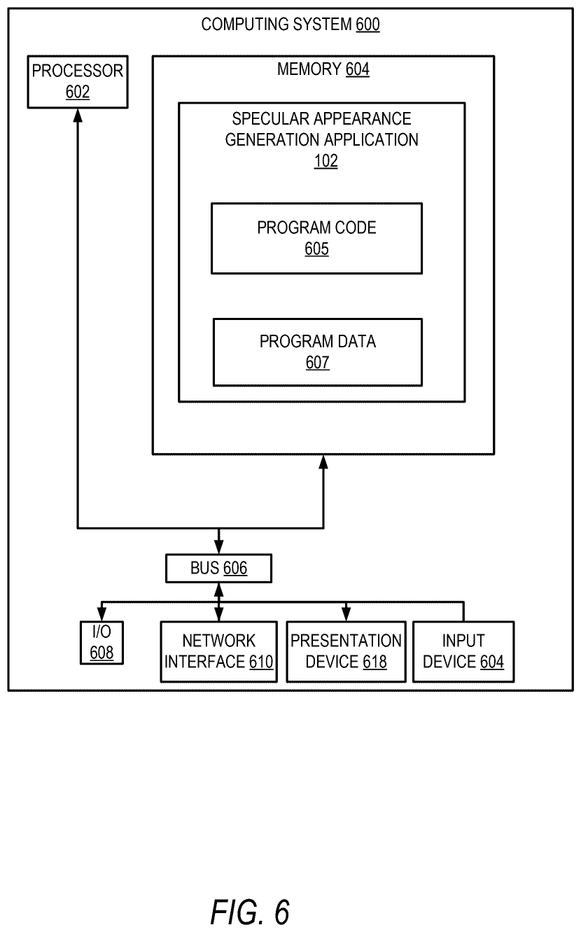

Referring now to the drawings, FIG. 1 depicts an example of a computing environment 100 in which a specular appearance generation application 102 provides a specular object rendering with a specular appearance including near-field interreflections and far-field reflections, according to certain embodiments of the present disclosure. In various embodiments, the computing environment 100 includes a computing system 101 in communication with client devices 130A, 130B, and 130C (which may be referred to herein individually as a client device 130 or collectively as the client devices 130) via a network 128. The network 128 may be a local-area network (“LAN”), a wide-area network (“WAN”), the Internet, or any other networking topology known in the art that connects the client device 130 to the specular appearance generation application 102. The computing system 101 can be a server or any other suitable computing device. In some examples, the computing system 101 is the computing system 600 as will be described in FIG. 6. The computing system 101 includes a specular appearance generation application 102. The client device 130 may be a desktop computer, a laptop computer, a mobile computing device or any other suitable computing device.

The client device 130 is configured to transmit multiple input images 114 for generating a specular appearance of a specular object. The input images 114 can include images depicting a specular object with a scene from different viewing directions. The specular object can have a specular surface, which is a smooth surface like a mirror to cause light rays to reflect at the same angle as they hit the surface. An input image can depict a specular appearance representing reflections of the scene on the specular surface of the object.

The 3D shape generation application 102 includes a neural directional encoding engine 104 configured to encode reflection features for a specular object in multiple viewing directions. The neural directional encoding engine 104 can include a far-field feature encoding module 106 and a near-field feature encoding module 108.

The far-field feature encoding module 106 encodes far-field reflections into a cubemap to provide a far-field feature representation 116. The far-field feature representation 116 can include learnable far-field feature vectors to encode direction. In some examples, the far-field feature encoding module 108 uses or implements a MIP mapping technique to the far-field feature representation 116 to account for rough reflections. Mipmapping is a technique in image processing that filters and scales an original, high-resolution texture map into multiple smaller-resolution texture maps, which are called mipmaps. The far-field feature encoding module 106 places far-field feature vectors at every pixel of a global cubemap to encode ideal specular reflections. The global cubemap is an imaginary cube including six square textures representing the reflections of a global environment on an object. The imaginary cube surrounds the object, each face representing the view of the object along the corresponding directions. The cubemap can be pre-filtered to model reflections under rough surfaces in the split-sum style. Given the surface roughness, the far-field feature encoding module 106 can perform a cubemap lookup in the reflected direction and interpolate between mipmap levels to obtain the far-field reflection feature vectors. The cubemap-based encoding can allow signals in different directions to be optimized independently by tuning the feature vectors, which is easier than globally solving MLP parameters. Thus, localized feature optimization using cubemap-based encoding is more suitable to model high-frequency reflection details in the angular domain. For example, the far-field feature encoding module 108 can only use a small MLP (e.g., 2 layers and 64 width) to model details in mirror reflections, which is comparable with existing encoding methods that require large MLPs (e.g., 8 layers, 256 width) and otherwise may fail when the MLP is small.

The near-field feature encoding module 108 can encode near-field interreflections into a volume to provide a near-field feature representation 118. Similar to the far-field feature representation 116, the near-field feature representation 118 can include learnable near-field feature vectors to encode direction. The near-field feature encoding module 108 also uses or implements a MIP mapping technique to the near-field feature representation 118 to account for rough reflections.

The near-field feature encoding module 108 can cone-trace a spatial volume accumulated along a reflected ray from the specular object to obtain near-field features. Spatio-angular reflection can be parameterized as a spatio-spatial function of current and next bounce location to capture the variation of bounce locations. Thus, the near-field feature encoding module 108 can model rough near-field reflections by cone tracing MIP-mapped spatial features covered by a reflection cone. Indirect rays can spatially vary, hence the cone-traced near-field features can be spatially varying too. This is advantageous over the angular-only feature for learning interreflections and is empirically less likely to overfit.

Far-field features and near-field features are similar to background and foreground colors in regular volume rendering. Thus, the far-field feature representation 116 and near-field feature representation 118 can be decoded and blended to represent specular colors on the surface of the specular object.

The 3D shape generation application 102 includes a specular appearance generation engine 110 configured to determine specular colors by decoding far-field features and near-field features. In some examples, the specular appearance generation engine 110 uses or implements an MLP algorithm to decode the far-field feature representation 116 and near-field feature representation 118 into color values separately and then blends them together as specular color values 120 for the specular object. Alternatively, or additionally, the specular appearance generation engine 110 blends the far-field features and near-field features and then decodes into specular color values 120.

In some examples, the specular appearance generation application 102 includes a specular object rendering engine 111 configured to generate and provide a digital model representing a specular object, using a neural rendering algorithm. A specular object representation 122 includes an SDF-based geometry model with the specular appearance represented by specular color values 120. The specular object rendering engine 111 can use or implement an optimization algorithm to optimize geometry model of the specular object. The geometry model of the specular object can be optimized, in tone-mapped space, through the Charbonnier loss between ground truth pixel colors and the specular colors determined by the specular appearance generation engine 110 as described above.

The data store 112 is configured to store data processed or generated by the specular appearance generation application 102. Examples of the data associated with a specular object stored in data store 112 include input images 114, far-field feature representation 116, near-field feature representation 118, specular color values 120, and a specular object representation 122. Training data used for training the MLP algorithms can also be stored in the data store 102. The network architecture shown in FIG. 1 is provided by way of example only. In other embodiments, the specular appearance generation application 102 could also or alternatively be executed locally on a client device 130 or on other device(s) not shown. The specular appearance generation application 102 can, in some embodiments, be a component of a larger software program, for example a graphics editing application.

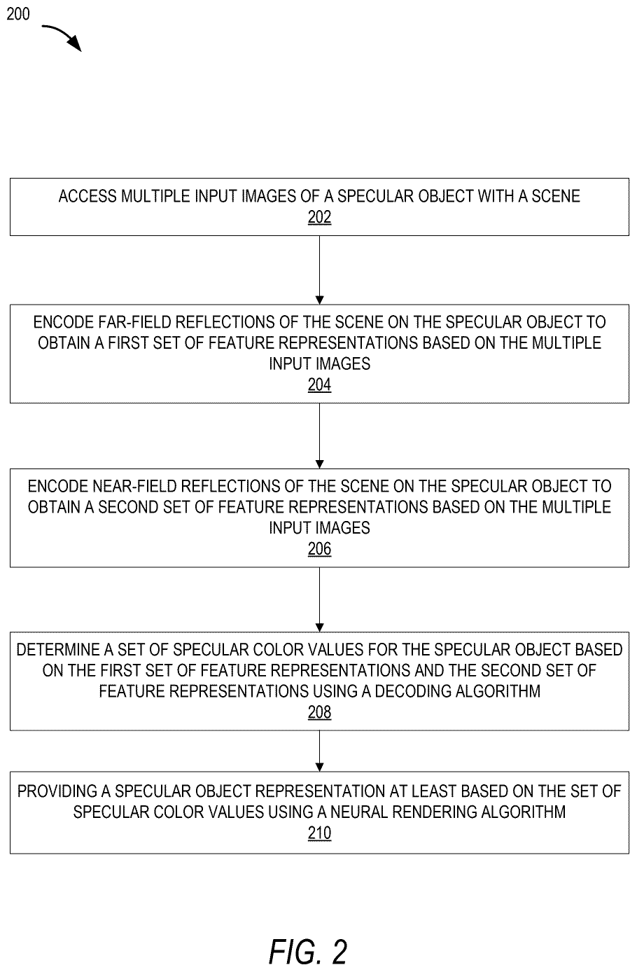

FIG. 2 depicts an example of a process 200 for providing a specular object model with specular color representing far-field reflection features and near-field reflection features, according to certain embodiments of the present disclosure.

At block 202, a computing system 101 accesses multiple input images of a specular object with a scene in multiple viewing directions. A scene is a setting or an environment around an object. A specular object can reflect or mirror the scene on its specular surface. The multiple input images of the specular object with the scene can be taken from different viewing points. The multiple input images can be provided to the computing system 101 by a client device 130, or it can be pre-stored in the datastore 112.

At block 204, the computing system 101 encodes far-field interreflections of the scene on the specular object to obtain a first set of feature representations based on the multiple input images. The scene reflected on the specular object can be represented by a surface-based model based on an SDF s(x) and a color field c(x, ω), where x is the origin point of a ray and ω is the viewing direction. The SDF can be converted to NeRF's density field σ following VolSDF with a learnable parameter β controlling the boundary smoothness, as shown in Equation (1) below.

$$σ ( x ) = \{ \begin{matrix}\frac{1}{2 β} exp ( \frac{s ( x )}{β} ) & if s ( x ) \leq 0 , \\ \frac{1}{β} ( 1 - \frac{1}{2} exp ( - \frac{s ( x )}{β} ) ) & otherwise .\end{matrix} \qquad ( 1 )$$

The color field of a ray with origin x and direction ω can be volume-rendered as shown in Equation (2) below. In equation (2), δⱼ=∥xᵢ−xᵢ₋₁∥₂ and xᵢ denotes the i^{th} sample point along the ray.

$$C ( x , ω ) = {\sum }_{i} w ( σ ( {x}_{i} ) ) c ( {x}_{i} , ω ) , where \qquad ( 2 )$$

$$ω ( σ ( {x}_{i} ) ) = ( 1 - {e}^{- σ ( {x}_{i} ) {δ}_{i}} ) {\prod }_{j < i} {e}^{- σ ( {x}_{j} ) {δ}_{j}}$$

The color field can be decomposed into a diffuse color component c_{d}, a specular tint component kₛ, and a specular color component cₛ queried in reflected direction ωᵣ with surface normal n given by the SDF gradient, as shown in Equation (3) below.

$$c ( x , ω ) = {c}_{d} ( x ) + {k}_{s} ( x ) {c}_{s} ( x , {ω}_{r} ) , where \qquad ( 3 )$$

$${ω}_{γ} = reflect ( ω , n ) , n = normalize ( {∇}_{x} s ( x ) )$$

The diffuse color c_{d}, specular tint kₛ, spatial feature f, and surface roughness ρ can be encoded using a hash grid and then decoded using a spatial MLP. The specular color component cₛ can be decoded by an MLP algorithm that conditions on spatial feature f(x), directional encoding H controlled by surface roughness ρ, and the cosine term n·ω, as shown in Equation (4).

$${c}_{s} ( x , {ω}_{r} ) = MLP ( f ( x ) , H ( x , {ω}_{r} , ρ ( x ) ) , n \cdot ω ) \qquad ( 4 )$$

To determine the specular color cₛ as shown in Equation (4), the directional reflection encoding H needs to be obtained. A neural direction encoding engine 104 of the specular appearance generation application 102 on the computing system 101 can determine the directional reflection encoding H using learnable neural directional encoding that depends on spatial location.

The neural direction encoding engine 104 encodes different types of reflections by different representations, including a spatial volume Hₙ that models near-field interreflections and a cubemap feature grid H_{f} representing far-field reflections, as shown in Equation (5), where aₙ is the cone-traced opacity. Both near-field features and far-field features are mipmapped with ρ deciding the mipmap level.

$$H ( x , {ω}_{r} , ρ ) = {H}_{n} ( x , {ω}_{r} , ρ ) + ( 1 - {α}_{n} ) {H}_{f} ( {ω}_{r} , ρ ) \qquad ( 5 )$$

The far-field feature encoding module 108 of the neural directional encoding engine 104 can encode far-field reflections to a cubemap. The cubemap is pre-filtered to model reflections under rough surfaces in a split-sum style, where the k^{th} level mipmapped far-field feature

$${h}_{f}^{k}$$

is created by convolving the down-sampled h_{f}. Given the surface roughness, the far-field feature can be obtained by cubemap lookup in the reflected direction and linear interpolation between MIP levels, as shown in Equation (6).

$${H}_{f} ( {ω}_{r} , ρ ) = lerp ( {h}_{f}^{k} ( {ω}_{r} ) , {h}_{f}^{k + 1} ( {ω}_{r} ) , \frac{ρ - {ρ}_{k}}{{ρ}_{k + 1} - {ρ}_{k}} ) \qquad ( 6 )$$

The cubemap-based encoding allows signals in different directions to be optimized independently by tuning the feature vectors, which is easier than globally solving the MLP parameters. Thus, the high-frequency details in the angular domain can be modeled with the cubemap-based encoding. Parameterizing specular colors by a spatial and angular feature can be sufficient for far-field reflections, but the specular colors may lack expressivity for near-field reflections. When different points query the same far-field feature, especially varying components can end up being averaged out during decoding optimization. Thus, it is important to obtain the near-field interreflection features so that the specular colors can be more accurately determined. Functions included in block 204 can be used to implement a step for encoding far-field reflections of the scene on the specular object to obtain a first set of feature representations based on the multiple input images.

At block 206, the computing system 101 encodes near-field reflections of the scene on the specular object to obtain a second set of feature representations based on the multiple input images using a cube-map feature grid. The near-field feature encoding module 108 of the neural directional encoding engine 104 encodes near-field features Hₙ into a spatial volume by cone tracing. Cone tracing volume-renders mipmapped spatial features hₙ using the mipmapped density σₙ along a reflected ray x+ωᵣt with mipmap level λᵢ=log₂(2rᵢ) at sample point

$${x}_{i}^{′}$$

decided by the cone's footprint rᵢ=\sqrt{3}ρ²∥x−xᵢ′∥₂, as shown in Equation (7) below.

$${H}_{n} ( x , {ω}_{r} , ρ ) = {\sum }_{i} {w}_{n}^{i} {h}_{n}^{i} , where \qquad ( 6 )$$

$${w}_{n}^{i} = w ( {σ}_{n} ( {x}_{i}^{′} , {λ}_{i} ) ) , {h}_{n}^{i} = {h}_{n} ( {x}_{i}^{′} , {λ}_{i} ) .$$

It is noted that Equation (6) does not use the SDF-converted density σ in Equation (1) but uses the mipmapped density σₙ. The mipmapped density σₙ and the indirect feature hₙ can be decoded from a tri-plane feature representation Tₙ, as shown in Equation (7).

$${σ}_{n} ( {x}_{i}^{′} , {λ}_{i} ) , {h}_{n} ( {x}_{i}^{′} , {λ}_{i} ) = MLP ( mipmap ( {T}_{n} ( {x}_{i}^{′} ) , {λ}_{i} ) ) \qquad ( 7 )$$

Functions included in block 206 can be used to implement a step for encoding near-field interreflections of the scene on the specular object to obtain a second set of feature representations of the specular object based on the multiple input images. Steps at block 204 and block 206 are independent of each other and can be performed in parallel or in series with a different order. In this example, the far-field reflections are encoded at block 204, and the near-filed reflections are encoded at block 206. Alternatively, the near-field reflections can be encoded first, and then the far-field reflections are encoded.

At block 208, the computing system 101 determines a set of specular color values for the specular object based on the first set of feature representations and the second set of feature representations using a decoding algorithm. With the first set of feature representation representing far-field reflections obtained at block 204 and the second set of feature representation representing near-field reflections obtained at block 206, the directional encoding H can be obtained based on Equation (5) as described at block 204. The specular appearance generation engine 110 can decode the directional encoding to obtain the set of specular color values, for example using a MLP algorithm, based on Equation (4) as described at block 204.

The near-field feature representations and far-field feature representations provides a natural separation of different reflections, which allows rendering these reflection effects separately by excluding Hₙ and H_{f} in Equation (5). In some examples, the specular appearance generation engine 110 decodes the first set of feature representations to obtain a first set of specular color values, decodes the second set of feature representations to obtain a second set of specular color values, and then blends the first set of specular color values and the second set of specular colors to obtain the set of specular color values for the specular object. In some examples, the specular appearance generation engine 110 blends or aggregates the first set of feature representations and the second set of feature representations to obtain an aggregated set of feature representations, and then decode the aggregated set of feature representations to obtain the set of specular color values for the specular object.

Interreflections cannot be reconstructed using only the far-field feature. Without cone-tracing the near-field feature, mirror interreflections can be recovered by volume-rendering but reflections on rough surfaces may look too sharp. Thus, a better specular appearance can be obtained by using both the cubemap-based far-field feature and the cone-traced near-field feature. The neural direction encoding can adapt feature-based NeRF encodings to the directional domain and provide a spatio-spatial parameterization of view-dependent appearance. These improvements can allow for efficient modeling of complex reflections for novel-view synthesis and benefit other applications that model spatially varying directional signals, such as neural materials and radiance caching.

At block 210, the computing system 101 provides a specular object representation at least based on the set of specular color values using a neural rendering algorithm. The specular object rendering engine 111 of the specular appearance generation application 102 in the computing system 101 can use or implement a neural rendering algorithm, for example a neural radiance fields (NeRF) algorithm, to provide the specular object representation.

As described at block 204, a specular object can be represented by a surface-based model based on a signed distance field (SDF) s(x) and a color field c(x, ω). As shown in Equation (3), the color field of the surface-based model can be determined based on the specular color and other components such as diffuse color c_{d} and specular tint kₛ. In some examples, the surface-based model is optimized, for example using Adam optimizer, by minimizing a Charbonnier loss between ground truth pixel color and the rendered specular colors in a tone-mapped space, as shown in Equation (8), where T is a tone-mapping function.

$$L = {\sum }_{x , w} \sqrt{{‖ T ( C ( x , w ) ) - {C}_{gt} ( x , w ) ‖}_{2}^{2} + 0.001} \qquad ( 8 )$$

In some examples, Eikonal loss is also considered to regularize the SDF values of the surface-based model. Additionally, the mipmapped density σₙ can be implicitly regularized to match the SDF-converted density σ by encouraging the rendering using σₙ at mipmap level 0 to be close to the ground truth, as shown in Equation (9), where _{c}^{∘} denotes stop-gradient to prevent σₙ from affecting the specular appearance. The total loss can be shown in Equation (10), which is a sum of the Charbonnier loss L, the SDF regularization loss Lₑᵢₖ, and the density regularization loss L_{σ}. The optimized SDF values can be obtained by minimizing the total loss, for example using an Adam optimizer.

$${L}_{σ} = {‖ T ( C ( x , w ) ) - {C}_{gt} ( x , w ) ‖}_{2}^{2} , where {C}_{σ} ( x , ω ) = {\sum }_{i} {w ( σ ( {x}_{i} , 0 ) )}_{C}^{°} ( {x}_{i} , w ) \qquad ( 9 )$$

$${L}_{total} = L + 0.1 {L}_{eik} + 0.01 {L}_{σ} \qquad ( 10 )$$

In some examples, the SDF values can be used to determine depth values and normal values. The depth values and normal values can be used to render a depth map and normal map respectively. The set of specular color values can be used to render an RGB map. The depth map, normal map, and the RGB map describe different aspects of the specular object. The specular object representation can include geometry and appearance. The geometry can be described by the depth map and the normal map. The specular appearance can be described by the normal map and the RGB map respectively.

In addition, a real-time version of the model can be created by converting the SDF into a mesh through marching cubes and baking other spatial features such as cd, ks, p, and f, into mesh vertices. The pixel color then can be computed using rasterized vertex attributes and cs decoded from neural directional encoding, which takes only a single cubemap lookup and cone tracing for each pixel. Using a smaller MLP width for decoding σₙ, hₙ, cₛ may have a slightly negative impact on the rendering quality but can significantly improves real-time performance.

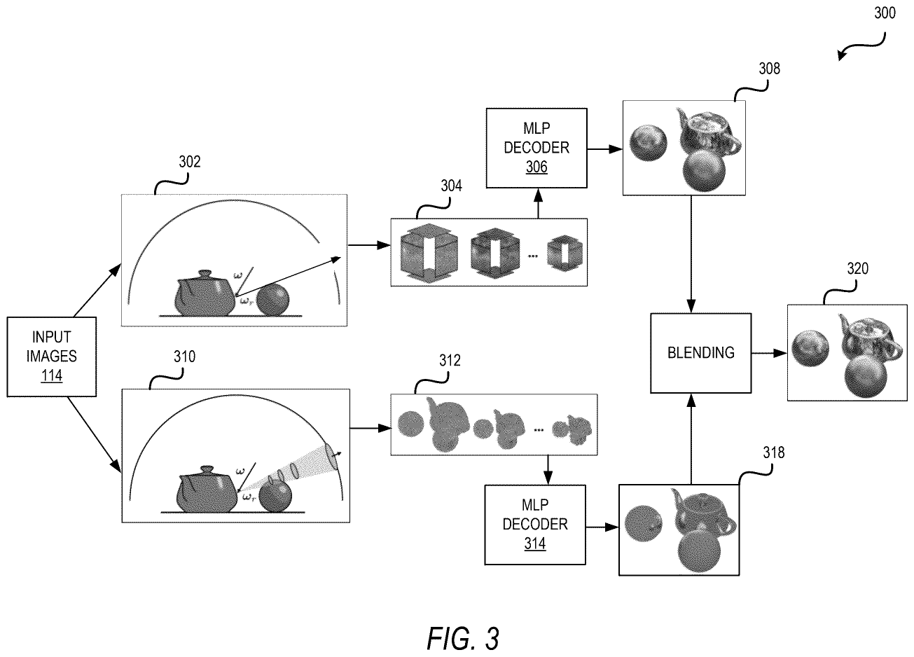

FIG. 3 depicts an example of a diagram 300 for generating a specular appearance for a specular object based on neural directional encoding, according to certain embodiments of the present disclosure. A set of input images 114 is provided to a far-field reflection encoder 302 and near-field reflection encoder 310. The set of input images 114 depict a tea kettle with specular surface and surrounded two balls with specular surface in different viewing directions. The far-field reflection encoder 302 encodes far-field reflections on the tea kettle and the two balls to provide a cubemap-based far-field feature representation 304. A MLP decoder 306 can decode the cubemap-based far-field feature representation 304 to specular color values, which can be rendered to represent far-field reflections 308 in various viewing directions. In parallel, the near-field reflection encoder 310 encodes near-field reflections on the tea kettle and the two balls to provide a cone-traced near-field feature representation 312. A MLP decoder 314 decodes the cone-traced near-field feature representation 312 to specular color values, which can be rendered to represent near-field reflections 318 on the tea kettle and the two balls. The MLP decoder 306 and the MLP decoder 314 can be the same decoder or different decoders. The far-field reflections 308 and the near-field reflections 318 are blended as the specular appearance model 320 of the tea kettle and the two balls. Alternatively, the cubemap-based far-field feature representation 304 and cone-traced near-field feature representation 312 are blended to become a blended feature representation. A MLP decoder then decodes the blended feature representation to provide the specular appearance model 320. The specular appearance model 320 can be rotated to showcase the specular appearance in different viewing directions.

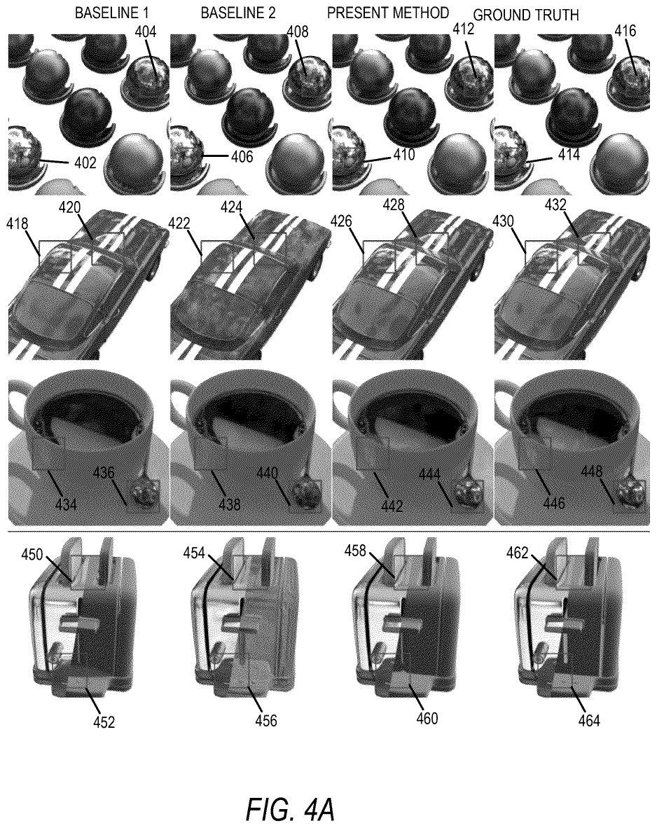

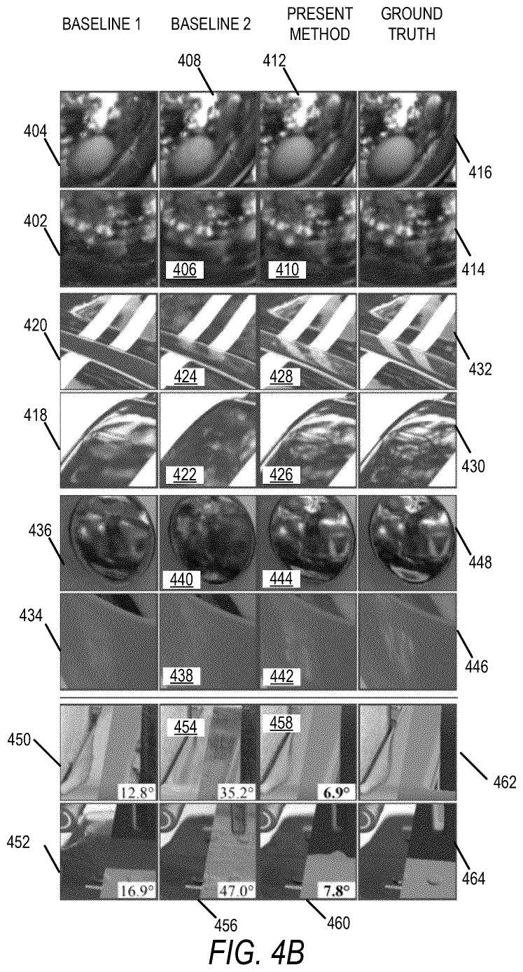

FIG. 4A depicts an example of a comparison of specular object renderings with synthetic scenes using different baseline methods and the present method, according to certain embodiments of the present disclosure. FIG. 4B depicts closed-up inset images in FIG. 4A, according to certain embodiments of the present disclosure. Images in FIG. 4A and FIG. 4B depict the reflections on the specular surfaces of balls, cars, coffee cup and saucer sets, and toasters. The present method with neural directional encoding can successfully model the fine details of reflections from both environment lights and other objects. Baseline method 2 tends to use wrong geometry to fake interreflections, for example as shown in inset 456. In contrast, the neural directional encoding in the present method has sufficient capacity to model interreflections, which enables more accurate normals, as shown in inset 458. Mean angular error of the normal is shown in the insets 450, 452, 454, 456, 458, 460, 462, 464. The mean angular errors of the normals generated by the present method are the smallest, as shown in insets 458 and 469.

Quantitative comparison of the renderings is shown in Table 1. The specular object renderings can be evaluated using evaluation metrics, such as peak signal-to-noise ratio (PSNR), Structural Similarity Index Measure (SSIM), and Learned Perceptual Image Patch Similarity (LPIPS). The PSNR value is a ratio between the maximum possible value (power) of a signal and the power of distorting noise that affects the quality of its representation. The higher the PSNR value, the better an image has been rendered to match the original image and the better the rendering algorithm. The SSIM value is computed based on three parameters such as luminance, contrast and structural information between a rendered image and a reference image. The higher the SSIM value is, the better the quality of the rendered image is. THE LPIPS value represents the distance between image patches. A higher LPIPS value means the images patches are more different. A lower LPIPS value means the images patches are more similar. As shown in Table 1, while the specular object renderings generated from baseline method 1 have slightly better SSIM scores than those generated from the present method, the PSNR scores and LPIPS scores are much higher for the renderings generated by the present method. The present method is either the best or second-best method compared to two baseline methods for view synthesis of specular objects.

TABLE 1
Quantitative comparison of specular object renderings with synthetic
scenes using baseline methods and the present method

| | | | | |
|---|---|---|---|---|
| Method | Toaster | Car | Ball | Coffee |

PSNR ↑

| | | | | |
|---|---|---|---|---|
| Baseline 1 | 26.63 | 29.88 | 41.03 | 34.45 |
| Baseline 2 | 25.70 | 30.82 | 47.46 | 34.21 |
| Present Method | 30.32 | 30.39 | 44.66 | 36.57 |

SSIM ↑

| | | | | |
|---|---|---|---|---|
| Baseline 1 | 0.955 | 0.972 | 0.997 | 0.984 |
| Baseline 2 | 0.922 | 0.955 | 0.955 | 0.974 |
| Present Method | 0.968 | 0.968 | 0.955 | 0.979 |

LPIPS ↓

| | | | | |
|---|---|---|---|---|
| Baseline 1 | 0.097 | 0.031 | 0.020 | 0.044 |
| Baseline 2 | 0.095 | 0.041 | 0.059 | 0.078 |
| Present Method | 0.039 | 0.024 | 0.022 | 0.033 |

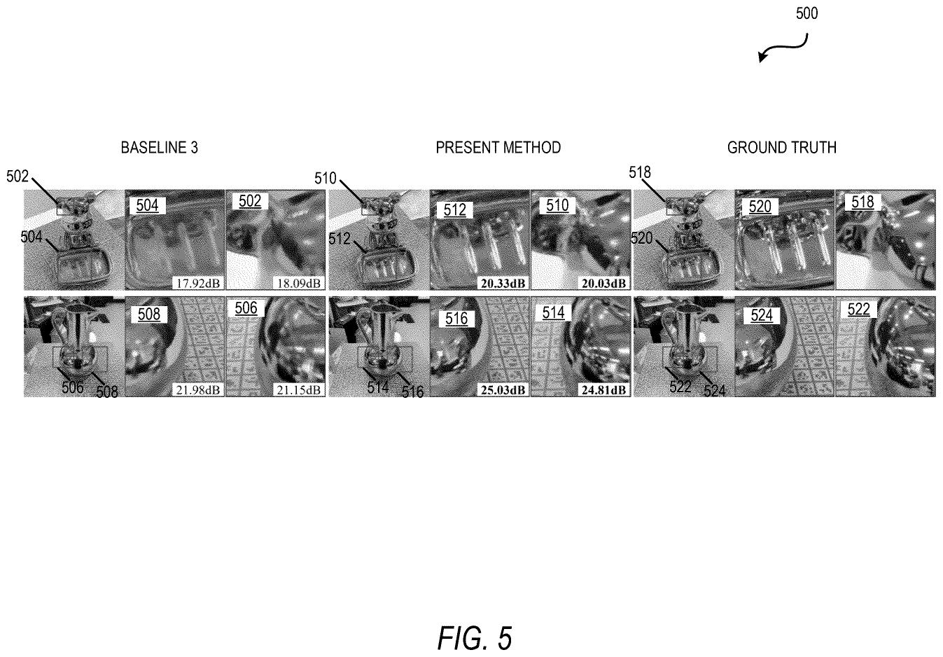

FIG. 5 depicts an example of a comparison of specular object renderings with real scenes using different baseline methods and the present method, according to certain embodiments of the present disclosure. For real scenes, Images in FIG. 5 depict the reflections on the specular surfaces of bear plates and vases. It can be seen in FIG. 5 that the present method with neural directional encoding gives better reconstruction of the interreflections and detailed highlights from the real-life environment, compared to baseline method 3. Numbers in the insets are image PSNR values. It can be seen that the PSNR values of the rendered images using the present method, as shown in inset images 510, 512, 514, and 516, are higher, than those in inset images 502, 504, 506, and 508 generated by baseline method 3.

Any suitable computing system or group of computing systems can be used for performing the operations described herein. For example, FIG. 6 depicts an example of the computing system 600 for implementing certain embodiments of the present disclosure. The implementation of computing system 600 could be used to implement the specular appearance generation application 102. In other embodiments, a single computing system 600 having devices similar to those depicted in FIG. 6 (e.g., a processor, a memory, etc.) combines the one or more operations depicted as separate systems in FIG. 1.

The depicted example of a computing system 600 includes a processor 602 communicatively coupled to one or more memory devices 604. The processor 602 executes computer-executable program code stored in a memory device 604, accesses information stored in the memory device 604, or both. Examples of the processor 602 include a microprocessor, an application-specific integrated circuit (“ASIC”), a field-programmable gate array (“FPGA”), or any other suitable processing device. The processor 602 can include any number of processing devices, including a single processing device.

A memory device 604 includes any suitable non-transitory computer-readable medium for storing program code 605, program data 607, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 600 executes program code 605 that configures the processor 602 to perform one or more of the operations described herein. Examples of the program code 605 include, in various embodiments, the application executed by the specular appearance generation application 102, or other suitable applications that perform one or more operations described herein. The program code may be resident in the memory device 604 or any suitable computer-readable medium and may be executed by the processor 602 or any other suitable processor.

In some embodiments, one or more memory devices 604 stores program data 607 that includes one or more datasets and models described herein. Examples of these datasets include far-field feature representations, near-field feature representations, specular color values, and specular object representations, etc. In some embodiments, one or more of data sets, models, and functions are stored in the same memory device (e.g., one of the memory devices 604). In additional or alternative embodiments, one or more of the programs, data sets, models, and functions described herein are stored in different memory devices 604 accessible via a data network. One or more buses 606 are also included in the computing system 600. The buses 606 communicatively couples one or more components of a respective one of the computing system 600.

In some embodiments, the computing system 600 also includes a network interface device 610. The network interface device 610 includes any device or group of devices suitable for establishing a wired or wireless data connection to one or more data networks. Non-limiting examples of the network interface device 610 include an Ethernet network adapter, a modem, and/or the like. The computing system 600 is able to communicate with one or more other computing devices (e.g., client device 130) via a data network using the network interface device 610.

The computing system 600 may also include a number of external or internal devices, an input device 620, a presentation device 618, or other input or output devices. For example, the computing system 600 is shown with one or more input/output (“I/O”) interfaces 608. An I/O interface 608 can receive input from input devices or provide output to output devices. An input device 620 can include any device or group of devices suitable for receiving visual, auditory, or other suitable input that controls or affects the operations of the processor 602. Non-limiting examples of the input device 620 include a touchscreen, a mouse, a keyboard, a microphone, a separate mobile computing device, etc. A presentation device 618 can include any device or group of devices suitable for providing visual, auditory, or other suitable sensory output. Non-limiting examples of the presentation device 618 include a touchscreen, a monitor, a speaker, a separate mobile computing device, etc.

Although FIG. 6 depicts the input device 620 and the presentation device 618 as being local to the computing device that executes the specular appearance generation application 102, other implementations are possible. For instance, in some embodiments, one or more of the input device 620 and the presentation device 618 can include a remote client-computing device that communicates with the computing system 600 via the network interface device 610 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

That which is claimed is:

1. A method performed by one or more processing devices, comprising:
accessing multiple input images of a specular object with a scene in multiple viewing directions;
encoding far-field reflections of the scene on the specular object to obtain a first set of feature representations based on the multiple input images;
encoding near-field interreflections of the scene on the specular object to obtain a second set of feature representations of the specular object based on the multiple input images;
determining a set of specular color values of the specular object based on the first set of feature representations and the second set of feature representations using a decoding algorithm; and
providing a specular object representation at least based on the set of specular color values using a neural rendering algorithm.

2. The method of claim 1, further comprising encoding the far-field reflections of the scene on the specular object into a cubemap to obtain the first set of feature representations, wherein the first set of feature representations of the specular object comprises cubemap-based far-field feature representations.

3. The method of claim 1, further comprising encoding the near-field interreflections of the scene by cone-tracing a spatial feature grid to obtain the second set of feature representations, wherein the second set of feature representations of the specular object comprises cone-traced near-field feature representations.

4. The method of claim 1, wherein determining the set of specular color values of the specular object based on the first set of feature representations and the second set of feature representations using a decoding algorithm comprising:
decoding the first set of feature representations to a first set of specular color values representing far-field reflections using the decoding algorithm;
decoding the second set of feature representations to a second set of specular color values representing near-field reflections using the decoding algorithm; and
blending the first set of specular color values and the second set of specular color values to obtain an aggregate set of specular color values of the specular object.

5. The method of claim 1, wherein determining the set of specular color values of the specular object based on the first set of feature representations and the second set of feature representations using a decoding algorithm comprising:
blending the first set of feature representations and the second set of feature representations to obtain an aggregate set of feature representations; and
decoding the aggregate set of feature representations to obtain an aggregated set of specular color values of the specular object.

6. The method of claim 1, wherein the decoding algorithm comprises a multi-layer perceptron (MLP) network, wherein the MLP network comprises two layers with a width of 64.

7. The method of claim 1, wherein the specular object representation further comprises an SDF-based geometry model.

8. The method of claim 7, further comprising optimizing the SDF-based geometry model of the specular object model based on the set of specular color values using an Adam optimizer.

9. The method of claim 1, further comprising providing the specular object representation in real time or near real time.

10. The method of claim 1, wherein the neural rendering algorithm comprises a neural radiance fields (NeRF) algorithm.

11. A system, comprising:
a memory component;
a processing device coupled to the memory component, the processing device to perform operations comprising:
accessing multiple input images of a specular object with a scene in multiple viewing directions;
encoding far-field reflections of the scene on the specular object to obtain a first set of feature representations based on the multiple input images; and
encoding near-field interreflections of the scene on the specular object to obtain a second set of feature representations of the specular object based on the multiple input images;
determining a set of specular color values of the specular object based on the first set of feature representations and the second set of feature representations using a decoding algorithm; and
providing a specular object representation at least based on the set of specular color values using a neural rendering algorithm.

12. The system of claim 11, wherein the processing device is to perform further operations comprising:
encoding the far-field reflections of the scene on the specular object into a cubemap to obtain the first set of feature representations, wherein the first set of feature representations of the specular object comprises cubemap-based far-field feature representations.

13. The system of claim 11, wherein the processing device is to perform further operations comprising:
encoding the near-field interreflections of the scene by cone-tracing a spatial feature grid to obtain the second set of feature representations, wherein the second set of feature representations of the specular object comprises cone-traced near-field feature representations.

14. The system of claim 11, wherein the processing device is to perform further operations comprising:
decoding the first set of feature representations to a first set of specular color values representing far-field reflections using the decoding algorithm;
decoding the second set of feature representations to a second set of specular color values representing near-field reflections using the decoding algorithm; and
blending the first set of specular color values and the second set of specular color values to obtain an aggregate set of specular color values of the specular object.

15. The system of claim 11, wherein the processing device is to perform further operations comprising:
blending the first set of feature representations and the second set of feature representations to obtain an aggregate set of feature representations; and
decoding the aggregate set of feature representations to obtain an aggregated set of specular color values of the specular object.

16. The system of claim 11, wherein the decoding algorithm comprises a multi-layer perceptron (MLP) network, wherein the MLP network comprises two layers with a width of 64.

17. The system of claim 11, wherein the specular object representation further comprises an SDF-based geometry model, wherein the processing device is to perform further operations comprising:
optimizing the SDF-based geometry model of the specular object model based on the set of specular color values using an Adam optimizer.

18. A non-transitory computer-readable medium, storing executable instructions, which when executed by a processing device, cause the processing device to perform operations comprising:
accessing multiple input images of a specular object with a scene in multiple viewing directions;
a step for encoding far-field reflections of the scene on the specular object to obtain a first set of feature representations based on the multiple input images;
a step for encoding near-field interreflections of the scene on the specular object to obtain a second set of feature representations of the specular object based on the multiple input images; and
providing a specular object representation at least based on a set of specular color values determined based on the first set of feature representations and the second set of feature representations.

19. The non-transitory computer-readable medium of claim 18, wherein the operations further comprise:
blending the first set of feature representations and the second set of feature representations to obtain an aggregate set of feature representations; and
decoding the aggregate set of feature representations using a decoding algorithm to obtain an aggregated set of specular color values of the specular object.

20. The non-transitory computer-readable medium of claim 18, wherein the specular object representation further comprises an SDF-based geometry model, wherein the operations further comprise:
providing a specular object representation by optimizing an SDF-based geometry model of the specular object representation based on the set of specular color values using an Adam optimizer.
